(19) United States
(12) Patent Application Publication
(10) Pub. No.: US 2015/0115584 A1
(43) Pub. Date: Apr. 30, 2015

(54) PARTIAL LOW RISK DEPLOYMENT VENT ASSEMBLY FOR AN AIRBAG ASSEMBLY

(71) Applicant: FORD GLOBAL TECHNOLOGIES, LLC, Dearborn, MI (US)

(72) Inventors: Eric A. Smitterberg, Berkley, MI (US); Edward J. Abramoski, Canton, MI (US); Jeff S. Vinton, Farmington Hills, MI (US)

(21) Appl. No.: 14/068,501

(22) Filed: Oct. 31, 2013

(51) Int. Cl. B60R 21/239; B60R 21/276

(52) U.S. Cl. CPC B60R 21/239; B60R 21/276
USPC 280/742; 29/454

(57) ABSTRACT

An exemplary vent assembly for an airbag assembly having an airbag cushion may have at least one panel attachable to the airbag cushion. The airbag cushion may be inflatable by a gas, and may define at least one opening that has a first area. The at least one opening may be configured to allow at least a portion of the gas to exit the airbag cushion. The at least one panel may be positionable over the at least one opening to partially obstruct the at least one opening.

### BACKGROUND

Vehicles employ airbags in various locations within the vehicle to restrain a vehicle occupant during load events, such as a crash. In such load events, the vehicle occupant may be forced in a specific direction at varying speeds, and therefore with varying kinetic energy. The airbag generally is positioned within the vehicle to come into contact with the occupant during such load events. The airbag generally is inflatable by a gas such that it may provide a cushion for the occupant and absorbs the kinetic energy from the occupant's movement.

In some situations, it may not be desired to have the airbag fully inflated and deployed when it comes into contact with the occupant. Such situations are known as partial low risk deployment (PLRD) events or out-of-position conditions, and may include, but are not limited to, when the occupant is a child, a small-size adult, a child in a rear-facing car seat, or an adult positioned too closely to the airbag. To account for these situations, many airbags include a vent or vent assembly that allows gas to vent during early deployment of the airbag, thereby slowing the inflation of the airbag. As the airbag nears full deployment and inflation, such as in non-PLRD events or in-position conditions, the vent may close to prevent any further gas from escaping the airbag.

Current manufacturing constraints require the vent to be of a minimum diameter or area. However, this minimum diameter or area may allow more gas to vent during early deployment of the airbag in both PLRD and non-PLRD events than is desired, which may result in slower deployment of the airbag.

Therefore, there exists a need for a vent assembly that minimizes the amount of gas loss during early deployment of an airbag.

### SUMMARY

An exemplary airbag assembly may include an airbag cushion that is inflatable by a gas from a stowed position to a fully deployed position. The airbag cushion may define at least one opening configured to allow at least a portion of the gas to exit the airbag cushion. The at least one opening may have a first area. The exemplary airbag assembly may also include at least one panel attached to the airbag cushion that may be positioned over at least a portion of the at least one opening. This may allow the at least one panel to partially obstruct the at least one opening.

An exemplary vent assembly for an airbag assembly having an airbag cushion may have at least one panel attachable to the airbag cushion. The airbag cushion may be inflatable by a gas, and may define at least one opening that has a first area. The at least one opening may be configured to allow at least a portion of the gas to exit the airbag cushion. The at least one panel may be positioned over the at least one opening to partially obstruct the at least one opening.

An exemplary method may include first providing at least one first panel in the shape of an airbag cushion. The exemplary method may then include cutting at least one opening in the at least one first panel, the at least one opening having a first area. The exemplary method may then include attaching at least one second panel to the at least one first panel, the at least one panel being positioned over at least a portion of the at least one opening to partially obstruct it. The exemplary method may further include forming the airbag cushion from the at least one first panel such that it defines an interior chamber and is inflatable by a gas. The at least one opening may be configured to allow at least a portion of the gas to exit the airbag cushion.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIGS. 1A and 1B are side views of an exemplary vehicle employing an exemplary airbag assembly in a partial low risk deployment (PLRD) event and a non-PLRD event, respectfully;

FIGS. 2A and 2B are enlarged, partial perspective views of an exemplary vent assembly of the exemplary airbag assembly of FIGS. 1A and 1B in an assembled state and an unassembled state, respectively;

FIGS. 3A, 3B, and 3C are plan views of different exemplary panels of the exemplary vent assembly of FIGS. 2A and 2B; and

FIG. 4 is a flow diagram illustrating an exemplary process of manufacturing the exemplary airbag assembly of FIGS. 1A and 1B.

### DETAILED DESCRIPTION

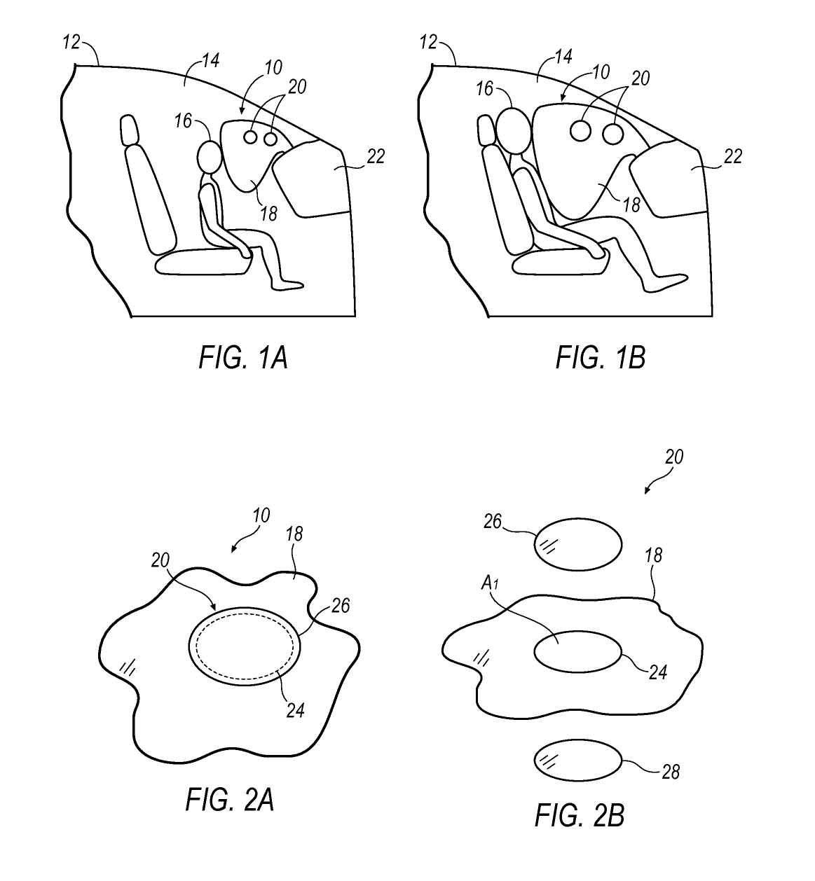

FIGS. 1A and 1B illustrate an exemplary airbag assembly 10 in a partially deployed position and a fully deployed position, respectively. The airbag assembly 10 may be implemented in a passenger compartment 14 of a vehicle 12 in which an occupant 16 may sit. The occupant 16 may be the driver or a passenger. Furthermore, the occupant 16 may be any size or age (e.g., a child or a small size adult, as seen in FIG. 1A, or an adult, as seen in FIG. 1B), and may even be a car seat within which a child may be seated. The vehicle 12 may be, but is not limited to, a sedan, a coupe, a van, a minivan, a sports utility vehicle, or the like. While the airbag assembly 10 is shown in the passenger side of the passenger compartment 14, it should be appreciated that the airbag assembly 10 may be in the driver side in addition to or in lieu of the passenger side. Furthermore, the airbag assembly 10 may be in any subsequent rows of the passenger compartment 14.

The airbag assembly 10 may be configured to deploy from a stowed position to a fully deployed position during a load event in which the vehicle 12 is subjected to a load, thereby causing the occupant 16 to move in a specific direction with a certain velocity. The airbag assembly 10 may include an airbag cushion 18 and at least one vent assembly 20. The airbag cushion 18 may be made of a flexible material and may define an interior chamber such that the airbag cushion 18 may be inflatable by a gas from the stowed position to the fully deployed position. In the stowed position, the airbag cushion 18 may be at least partially deflated and stored in a compartment in a component 22 of the vehicle 12. The component 22 may include, but is not limited to, a glove compartment, a steering column, a dashboard, and the like. In at least a partially deployed position, i.e., any position between the stowed position and the fully deployed position, the airbag cushion 18 may be configured to contact the occupant 16 during a load event, thereby offering a degree of protection to the body and/or head of the occupant 16.

The vent assembly 20 may be configured to allow gas to vent from the interior chamber of the airbag cushion 18 at least during initial deployment of the airbag assembly 10. This may be particularly beneficial in partial low-risk deployment (PLRD) events in which the occupant 16 may be positioned with respect to the airbag assembly 10 such that the occupant 16 may come into contact with the airbag cushion 18 prior to full deployment. For example, this may occur when the occupant 16 is a child, a small size adult, a child in a rear-facing car seat, or an adult simply positioned closer to the airbag assembly 10. In PLRD events, it may be desirable to reduce the speed at which the airbag cushion 18 is inflated and therefore reduce the impact of the occupant 16 with the airbag cushion 18, which may be accomplished by the vent assembly 20. While two vent assemblies 20 are shown, it should be appreciated that there may be any number of vent assemblies 20, and they may be in varying sizes, as described below. Furthermore, the vent assemblies 20 may be located in a substantially similar location on the other side of the airbag cushion 18 such that the gas may be vented substantially equally from each side of the airbag cushion 18 to allow for substantially uniform deployment.

Referring now to FIGS. 2A and 2B, the vent assembly 20 is shown in an assembled state and an unassembled state, respectively. The vent assembly 20 may include an opening 24 defined by the airbag cushion 18. The opening 24 generally may have a defined area A₁. In one exemplary approach, the opening 24 may be substantially circular in shape with a diameter ranging from 50 mm to 100 mm. However, it should be appreciated that the opening 24 may be any shape and size that may allow the gas to vent from the interior chamber of the airbag cushion 18 at a desired rate.

The vent assembly 22 also may include a panel 26 configured to reduce the amount of gas that may pass through the opening 24. The panel 26 may be attached to the airbag cushion 18. In one exemplary approach, the panel 26 may be attached by being sewn to the airbag cushion 18. In another exemplary approach, the panel 26 may be attached via an adhesive. While FIGS. 2A and 2B illustrate the panel 26 being attached to the airbag cushion 18 from the exterior, it should be appreciated that it may be attached from within the interior chamber of the airbag cushion 18. Furthermore, while the panel 26 is shown as being substantially circular in shape, it should be appreciated that it may be any shape and size that allows it to at least partially cover the opening 24 and to be attached to the airbag cushion 18. Moreover, while the panel 26 is shown as having a similar shape as the opening 24, the shapes need not be similar.

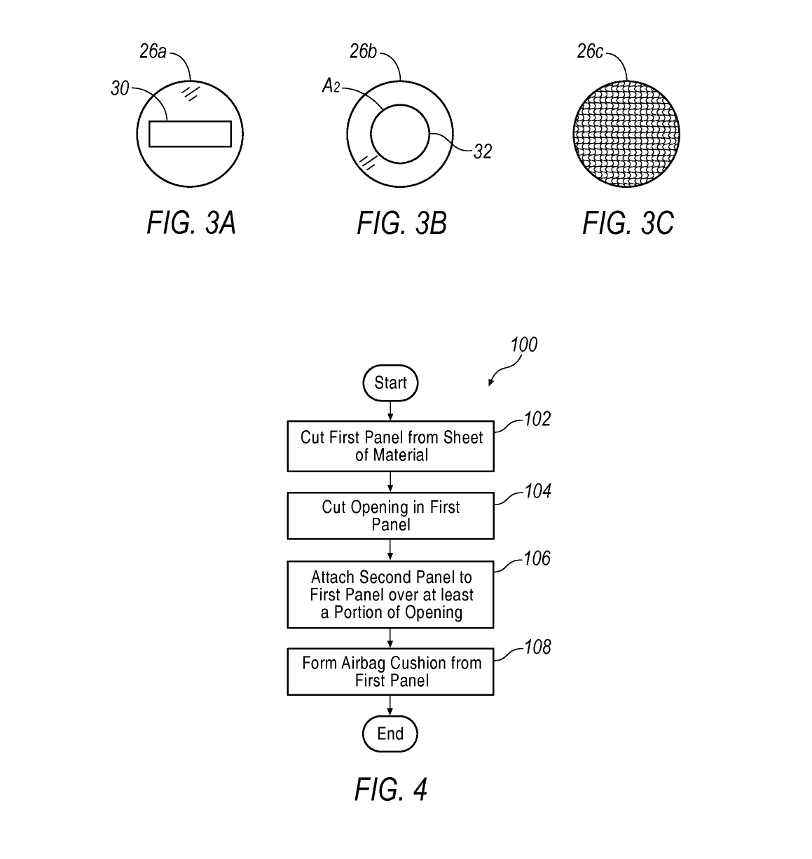

The panel 26 may be made of any fabric or other material, including, but not limited to, the same material as the airbag cushion 18. As explained above, the panel 26 may reduce the amount of gas that may be vented through the opening 24. The panel 26 may be configured in various approaches to accomplish this, e.g., as seen in the exemplary illustrations shown in FIGS. 3A through 3C. In the exemplary approaches depicted in FIGS. 3A and 3B, the panels 26a and 26b may be non-permeable membranes that reduce the area A₁ of the opening 24. Merely as one example, the reduction in the area A₁ may range from 30% to 50%. To accomplish this, the panels 26a and 26b may define a slot 30 and an aperture 32, respectively, through which the gas may pass. The slot 30 and the aperture 32 generally may have an area A₂ that is smaller than the area A₁. While one slot 30 and one aperture 32 are shown in FIGS. 3A and 3B, respectively, it should be appreciated that there may be any number of slots to achieve the desired reduction in area and gas flow while still maintaining the structural integrity of the panels 26a and 26b. It should also be appreciated that the shapes illustrated, i.e., the slot 30 and the aperture 32, are merely examples and that an aperture or opening may be provided in the panel 26 of any size and shape that is convenient.

In another exemplary approach depicted in FIG. 3C, the panel 26c may be made of a permeable membrane, including, but not limited to, a mesh-like material. The permeable membrane may allow a selective amount of gas to pass through the permeable material, thereby allowing the gas to pass through the opening 24. Moreover, the permeable material still restricts the passage of the gas through the opening 24 as compared with an unobstructed opening 24. It should be appreciated that any combination of the exemplary approaches described above, in addition to any other approaches, are within the scope of the present disclosure.

Referring back to FIGS. 2A and 2B, the vent assembly 22 further may include a vent cover 28 configured to at least substantially cover the opening 24 as the airbag cushion 18 inflates substantially to the fully deployed position. In non-PLRD events, such as when the occupant 18 is an adult and is positioned at a certain distance away from the airbag assembly 10, it may be desirable to have the airbag cushion 18 substantially inflated and deployed prior to coming into contact with the occupant 14 to be most effective. As such, the vent assembly 22 should allow minimal to no gas to be lost, which may be achieved by the vent cover 28. The vent cover 28 may be, but is no limited to a flap, a panel, and the like, and may be oriented in any position over, around, or adjacent to the opening 24. Furthermore, the vent cover 28 may be configured to cover the opening 24 from within the interior chamber of the airbag cushion 18, as depicted from FIGS. 2A and 2B, or from without. As an example, the vent cover 28 may be moved into place over the opening 24 via at least one tether (not shown) within the airbag cushion 18. More specifically, the vent cover 28 may be pulled into place by the tether (not shown) as the airbag deploys, thereby substantially or entirely closing the opening 24. By contrast, when the airbag is obstructed, e.g., by an out-of-position occupant, the vent cover 28 remains open with respect to the opening 24, thereby preventing a full deployment of the airbag.

Referring now to FIG. 4, an exemplary process 100 for manufacturing the airbag assembly 16 is shown. At block 102, process 100 may include providing at least one panel in the shape of the airbag cushion 18. For example, a panel may be generally cut from a sheet of material into a desired shape of the airbag cushion 18. At block 104, process 100 may include cutting at least one opening 24 in the at least one panel of material. At block 106, process 100 may include attaching a panel 26 to the at least one panel of material over at least a portion of the opening 24. As explained above, the panel 26 may be configured to reduce the amount of gas flow through the opening 24. This may be achieved by cutting at least one slit 30 and/or at least one aperture 32 in the panel 26, which may be performed before or after attaching the panel 26 to the at least one panel of material. Alternatively or in addition, the panel 26 may be a permeable membrane, such as a mesh-like material. At block 108, process 100 may include forming the airbag cushion 18 from the at least one panel of material such that it defines an interior chamber that is inflatable by a gas. This may be done by sewing the at least one panel with itself or another panel cut from the sheet of material. Process 100 may also include installing a vent cover 28 to selectively cover the opening 24. This may be performed before or after blocks 104 and/or 106. Process 100 ends after block 108.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An airbag assembly comprising:
an airbag cushion inflatable by a gas from a stowed position to a fully deployed position, the airbag cushion defining at least one opening configured to allow at least a portion of the gas to exit the airbag cushion, the at least one opening having a first area; and
at least one panel attached to the airbag cushion and positioned over at least a portion of the at least one opening such that the at least one panel partially obstructs the at least one opening.

2. The airbag assembly of claim 1 wherein the at least one panel is formed of a non-permeable membrane and reduces the first area of the at least one opening.

3. The airbag assembly of claim 2 wherein the reduction of the first area ranges from 30% to 50%.

4. The airbag assembly of claim 2 wherein the at least one panel defines at least one slot having a second area that is smaller than the first area of the at least one opening.

5. The airbag assembly of claim 2 wherein the at least one panel defines at least one aperture having a second area that is smaller than the first area of the at least one opening.

6. The airbag assembly of claim 1 wherein the at least one panel is made of a permeable membrane.

7. The airbag assembly of claim 1 further comprising at least one vent cover configured to selectively substantially cover the at least one opening.

8. The airbag assembly of claim 1 wherein at least one of the at least one opening and the at least one panel is substantially circular in shape.

9. A vent assembly for an airbag assembly having an airbag cushion inflatable by a gas, the airbag cushion defining at least one opening that has a first area, the at least one opening being configured to allow at least a portion of the gas to exist the airbag cushion, the vent assembly comprising at least one panel attachable to the airbag cushion and positionable over at least a portion of the at least one opening to partially obstruct the at least one opening.

10. The vent assembly of claim 9 wherein the at least one panel is made of a non-permeable membrane and reduces the first area of the at least one opening.

11. The vent assembly of claim 10 wherein the at least one panel defines at least one slot having a second area that is smaller than the first area of the at least one opening.

12. The vent assembly of claim 10 wherein the at least one panel defines at least one aperture having a second area that is smaller than the first area of the at least one opening.

13. The vent assembly of claim 9 wherein the at least one panel is made of a permeable membrane.

14. The vent assembly of claim 9 further comprising at least one vent cover configured to selectively substantially cover the at least one opening.

15. A method comprising:
providing at least one first panel in the shape of an airbag cushion;
cutting at least one opening in the at least one first panel, the at least one opening having a first area;
attaching at least one second panel to the at least one first panel, the at least one second panel being positioned over at least a portion of the at least one opening to partially obstruct it; and
forming the airbag cushion from the at least one first panel such that it defines an interior chamber and is inflatable by a gas;
wherein the at least one opening is configured to allow at least a portion of the gas to exit the airbag cushion.

16. The process of claim 15 wherein the at least one second panel is made of a non-permeable membrane.

17. The process of claim 16 further comprising cutting at least one of at least one slot and at least one aperture in the at least one second panel that collectively have a second area smaller than the first area of the at least one opening.

18. The process of claim 17 wherein the second area is 30% to 50% smaller than the first area.

19. The process of claim 15 wherein the at least one second panel is made of a permeable membrane.

20. The process of claim 15 further comprising installing a vent cover to the at least one first panel to selectively cover the at least one opening.
